(19) United States
(12) Patent Application Publication
(10) Pub. No.: US 2004/0090677 A1
(43) Pub. Date: May 13, 2004

(54) Material measure in the form of an amplitude grating, as well as a position measuring system

(76) Inventors: Michael Allgauer, Altenmarkt (DE); Georg Flatscher, Schneizlreuth (DE); Stefan Marchfelder, Ubersee (DE)

Correspondence Address: GENERAL NUMBER 00757, BRINKS HOFER GILSON & LIONE, P.O. BOX 10395, CHICAGO, IL, 60611, US

(21) Appl. No.: 10/637,743

(22) Filed: Aug. 7, 2003

(30) Foreign Application Priority Data
Aug. 10, 2002 (DE) 102 36 788.4

(51) Int. Cl. G02B 5/18; G02B 27/44; G02B 5/08; G02B 7/182

(52) U.S. Cl. 359/566; 359/883

(57) ABSTRACT

A material measure in the form of an amplitude grating including a first reflecting layer, a second transparent layer and a third layer, which is partially transparent to light, the third layer comprising a measuring graduation, wherein the second layer is arranged between the first layer and the third layer.

Applicants claim, under 35 U.S.C. §119, the benefit of priority of the filing date of Aug. 10, 2002 of a German patent application, copy attached, Serial Number 102 36 788.4, filed on the aforementioned date, the entire contents of which is incorporated herein by reference.

### BACKGROUND OF THE INVENTION

1. Field of the Invention

The present invention relates to a material measure in the form of an amplitude grating, includes several reflecting layers. The present invention further relates to a position measuring system having a light source and a material measure in the form of an amplitude grating.

2. Discussion of Related Art

An amplitude grating is used as the material measure of an optoelectrical position measuring system for measuring the relative position of two objects which can be moved in relation to each other. Such amplitude gratings are often employed in the form of incident light amplitude gratings in position measuring systems. Customarily, reflecting areas or marks are located next to non-reflecting gaps in amplitude gratings. The degree of reflection of the marks should be as strong as possible in order to obtain a strong signal in the end, and accordingly the degree of reflection of the gaps should be correspondingly low. A high degree of modulation can be achieved in this way. Amplitude gratings are often made of a steel tape, to which marks of well reflecting gold have been applied, and wherein the gaps include roughly etched steel, which has a comparatively low degree of reflection. However, material measures of this type have the disadvantage that the gaps have a comparatively poor absorption capability, or a degree of reflection which is relatively still too high. Moreover, this known design is not insensitive to soiling or contamination. In this case, soiling or contamination is understood to include, for example, of droplets of cooling agents or lubricants, or dust particles.

A phase grating is described in EP 0 160 784 A2 of Applicant, which corresponds to U.S. Pat. No. 4,708,437, the entire contents of which is incorporated herein by reference. Phase gratings are intended to have a great diffraction efficiency and, connected therewith, as high as possible a degree of reflection of all reflecting layers on it, so that in the respective position measuring systems the measuring signal is as strong as possible in comparison to the noise signals. The phase grating includes two spaced-apart reflecting layers, which are arranged on both sides of a transparent distance layer. Phase gratings have the disadvantage that they are relatively elaborate both in their production, as well as with respect to their incorporation into a position measuring system.

### OBJECT AND SUMMARY OF THE INVENTION

An object of the present invention is based on disclosing a material measure in the form of an amplitude grating which is insensitive to soiling or contamination, can be produced cost-effectively, and has areas of a very high degree of reflection next to areas with a very low degree of reflection.

In accordance with the present invention, this object is attained by a material measure in the form of an amplitude grating including a first reflecting layer, a second transparent layer and a third layer, which is partially transparent to light, the third layer comprising a measuring graduation, wherein the second layer is arranged between the first layer and the third layer.

It is furthermore intended to disclose a position measuring system with such a material measure, which can be produced more economically and whose properties and characteristics are mentioned in a position measuring system including a light source that generates light of a wavelength λ and a material measure in the form of an amplitude grating that receives the light. The material measure includes a first reflecting layer, a second transparent layer having a refractive index n and a thickness d2; and a third layer, which is partially transparent to the light and the third layer includes a measuring graduation. The second layer is arranged between the first layer and the third layer and the thickness d₂ fits the inequality

d₂<λ/(4·n).

The advantages to be gained by the present invention includes in particular in that it is now possible to produce incident light amplitude gratings which have a good degree of modulation of the employed light, or an extremely large contrast between reflecting and non-reflecting areas. Moreover, the novel amplitude grating, or the novel position measuring system, is very insensitive in regard to soiling or contamination.

The present invention is based in particular on the concept that by the application of partially transparent areas on a spacing layer, which itself rests on a reflecting layer, it is possible to achieve extremely low degrees of reflection in these areas. Furthermore, an insensitivity to soiling or contamination can be noted because of the reduced thickness of the partially transparent areas, because an almost planar surface is created in this way. Added to this is that such a surface permits easy cleaning of the amplitude grating.

The position measuring system should advantageously have an amplitude grating whose spacing layer is thinner than λ/(4−n), wherein λ is understood to be the wavelength of a light source of the position measuring system and n the refractive index of the spacing layer.

The refractive index expresses the ratio of reflected light energy to the light energy impinging on the reflective layer. Therefore the refractive index can maximally achieve the value 1, or 100%. In what follows, it will be expressed in connection with a wavelength of the light in a range between 250 nm and 1600 nm, for example 670 nm. The angle of incidence of the light is 0° for determining the refractive index, i.e. it extends perpendicularly or orthogonally in relation to the reflector plane. In what follows, a reflecting layer is understood to be a layer having a degree of reflection of at least 50%, preferably at least 75%.

In what follows, transparent layers are meant to be layers which absorb less than 30%, advantageously less than 10% of the light radiation when it passes perpendicularly.

Finally, a partially transparent layer is meant to be a layer which, with a light beam impinging perpendicularly, reflects less than 50%, preferably less than 30%, of the intensity of the light beam, and allows more than 7%, advantageously more than 20%, of the intensity of the light beam to pass through.

Further details and advantages of the method in accordance with the present invention, as well as of the amplitude grating in accordance with the present invention and a corresponding position measuring system, ensue from the subsequent description of an exemplary embodiment by the attached drawings.

### BRIEF DESCRIPTION OF THE DRAWINGS

FIG. 1 represents a cross section through an embodiment of an amplitude grating in accordance with the present invention; and

FIG. 2 is an embodiment of a position measuring system that includes the amplitude grating of FIG. 1 in accordance with the present invention.

### DETAILED DESCRIPTION OF THE PREFERRED EMBODIMENTS

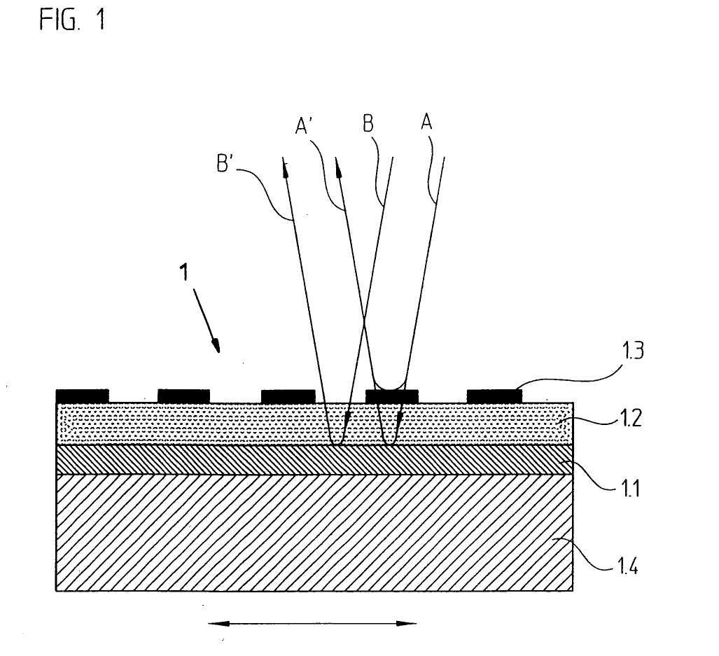

In accordance with FIG. 1, an amplitude grating 1 includes a substrate 1.4, having a steel layer of a thickness of 400 μm, to which a reflecting layer 1.1 has been applied. In the example shown, the reflecting layer 1.1 includes a 60 nm thick layer of gold and has a good degree of reflection of better than 90%.

Moreover, a material measure structure is also covered by the present invention, in which a substrate 1.4 is totally omitted. For example, the reflecting layer 1.1 can be embodied to be so thick that it also is used as a support body. In this case the reflecting layer 1.1 would include a polished aluminum or steel tape.

A spacing layer 1.2 is located on the reflecting layer 1.1, which is transparent and here is embodied as a 110 nm thick SiO₂ layer. Because of its material and its thickness, the spacing layer 1.2 is fully transparent for all practical purposes.

Partially transparent graduation marks 1.3 are represented on the spacing layer 1.2 in FIG. 1 which, in the example shown, includes 4 nm thick chromium. The graduation marks are 10 μm wide and have a spacing of also 10 μm, so that in principle these graduation marks 1.3 represent the measuring graduation, or a layer interrupted in accordance with the measuring graduation. The extremely low thickness of the graduation marks 1.3 is the reason for their partially transparent properties and, at the same time, results in an almost planar surface of the amplitude grating. Especially since the thin, partially transparent graduation marks 1.3 result in only negligible elevations on the surface, which as a rule are less than the customary unevenness caused by the roughness, the amplitude grating 1 is insensitive to soiling or contamination and easy to clean, if required. Further than that, the chromium of the graduation marks 1.3 adheres so well to the spacing layer 1.2 that the amplitude grating can be mechanically cleaned without problems and without the graduation marks 1.3 becoming damaged.

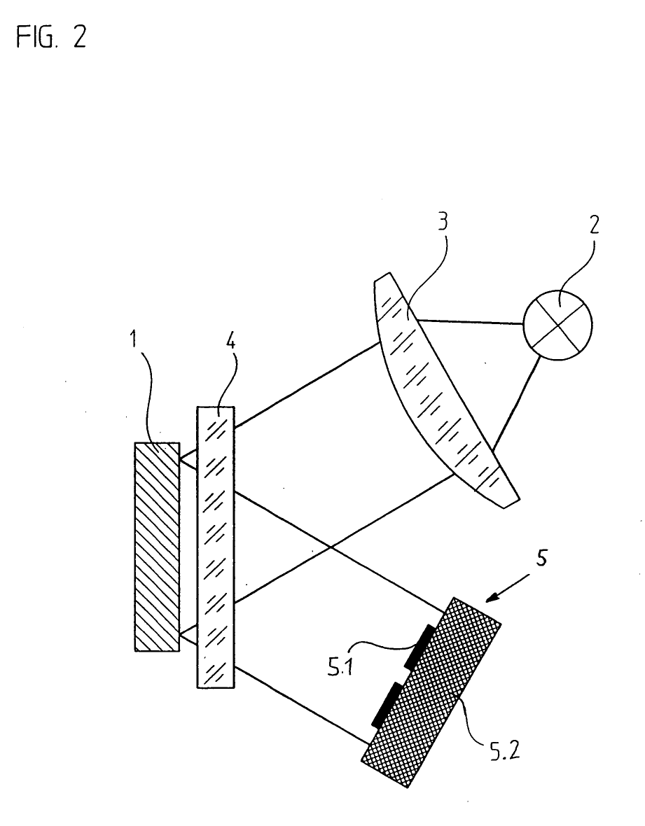

Optical elements of a position measuring system are schematically represented in FIG. 2. Accordingly, the position measuring system contains the amplitude grating 1, a light source 2, a condenser 3, a scanning plate 4 with lines arranged like a grating, for example, between the condenser 3 and the amplitude grating 1, as well as a photo-detector 5. The photo-detector 5 itself includes photo-electric sensors 5.1, in the represented example on a semiconductor basis, and a support substrate 5.2, embodied as printed circuit board material.

In the example shown, the light source 2 radiates light of a wavelength lambda of approximately 860 nm. The mode of functioning of the position measuring system is based on a shadow-optical principle. In this case the light is aligned parallel by the condenser 3 and then passes through the scanning plate 4, which has lines arranged like a grating, for example. Thereafter the light is reflected, or absorbed, by the amplitude grating 1 in accordance with the measuring graduation of the amplitude grating 1. The amplitude grating 1 is displaceable with respect to the light source 2, the condenser 3, the scanning plate 4 and the photo-detector 5 in accordance with the two-headed arrow in FIG. 1, wherein the displacement causes a position-dependent modulation of the light, which is converted into position-dependent electrical signals by the photo-detector 5, or the photo-electric sensors 5.1.

The optical function of the amplitude grating 1 can be explained in a greatly simplified way by FIG. 1. The light beam A impinges on the partially transparent graduation mark 1.3 and is partially reflected by the latter and partially allowed to pass. In the represented example, 25% of the original light intensity are reflected at the graduation mark 1.3. In the course of the passage through the partially transparent graduation mark 1.3, approximately 40% of the remaining, not reflected 75% of the original light intensity are absorbed.

When the light radiates through the transparent spacing layer 1.2, practically no weakening of the light occurs, so that approximately 45% of the light reach the reflecting layer 1.1. The reflecting layer 1.1. reflects approximately 90% of the impinging light intensity so that, in reference to the original light intensity still 40.5% of the light exist after reflection. This light now again passes through the partially transparent layer and again loses 40% because of this, so that the light beam A′ has only 24.3% of the original light intensity of the light beam A. As already mentioned, approximately 25% of the light intensity of the light beam A had already been reflected at the graduation mark 1.3. Thus, the intensity of the light reflected at the graduation marks 1.3 is approximately as great as the intensity of the light leaving the graduation mark 1.3.

But these rays, the one reflected by the graduation mark 1.3 and the one exiting the graduation mark 1.3, have a phase offset by 180°. The size of the phase difference mainly depends on the wavelength λ of the light source 2, the thickness d₂ of the spacing layer 1.2 and the refractive index n of the spacing layer 1.2. Moreover, the angle of incidence of the light at the amplitude grating 1, the dependence of the material of the phase jump at the reflecting layer 1.1 and the absorption degree k of the graduation marks 1.3 play a role, albeit a subordinate one, in the size of the phase difference achieved. An extinction of the light beam in the area of the graduation marks 1.3 can be noted if the phase difference between the beams mirrored at the graduation marks 1.3 and those at the reflecting layer 1.1 is 180° or a multiple thereof. In a first approximation, the thickness d₂ of the spacing layer 1.2 can be determined by the correlation d₂=(2 m+1)·λ(4·n), wherein m can be a whole number from zero to infinity. In a preferred embodiment, such as represented in the example, the thickness d₂ of the spacing layer 1.2 is selected to be as little as possible, so that m=0 is used. The as little as possible thickness d₂ has, inter alia, advantages in regard to the efficiency of the production method (short dwell time in the process) and to the reduction of mechanical stresses in the layer structure of the amplitude grating 1.

With a wavelength λ of 860 nm and a refractive index n=1.5 of the, spacing layer 1.2, a value of approximately 143 nm results for the layout of d₂ in a first approximation. Following the correction in regard to the further above mentioned influences, an optimal thickness d2 of the spacing layer 1.2 of 110 nm is finally determined. This results in an extensive extinction in the area of the graduation marks 1.3, so that the light beam A′ has a very low intensity.

In contrast thereto, the beam B enters the transparent spacing layer 1.2 at full intensity and hardly loses any energy inside it. Only by being reflected at the reflecting layer 1.1 does the light lose approximately 10% of its intensity. Accordingly, a light beam B′ exits between the graduation marks 1.3 at an intensity of 90% in relation to the impinging light. These areas therefore appear as being very light.

Since the light beam A′ has a very low intensity, and in contrast the light beam B′ a correspondingly high intensity, it is possible to generate high quality position signals in the position measuring system, which can be further processed very well, for example interpolated, so that a precisely operating position measuring system can be achieved.

Further exemplary embodiments exist within the scope of the present invention besides the described examples.

We claim:

1. A material measure in the form of an amplitude grating, comprising:
a first reflecting layer;
a second transparent layer; and
a third layer, which is partially transparent to light, said third layer comprising a measuring graduation, wherein said second layer is arranged between said first layer and said third layer.

2. The material measure in accordance with claim 1, wherein said first layer is applied to a base layer.

3. The material measure in accordance with claim 1, wherein said first layer comprises gold.

4. The material measure in accordance with claim 1, wherein said second layer comprises SiO₂.

5. The material measure in accordance with claim 3, wherein said second layer comprises SiO₂.

6. The material measure in accordance with claim 1, wherein said third layer comprises chromium.

7. The material measure in accordance with claim 3, wherein said third layer comprises chromium.

8. The material measure in accordance with claim 4, wherein said third layer comprises chromium.

9. The material measure in accordance with claim 5, wherein said third layer comprises chromium.

10. The material measure in accordance with claim 1, wherein said third layer has a thickness d₂ of less than 10 nm.

11. The material measure in accordance with claim 10, wherein said third layer has a thickness d₂ of less than 5 nm.

12. The material measure in accordance with claim 1, wherein said third layer has a degree of reflection of less than 50%.

13. The material measure in accordance with claim 1, wherein said second layer has refractive index n and a thickness d₂ that fits the inequality
d₂<λ/(4·n), wherein λ is the wavelength of light that impinges upon said material measure.

14. A position measuring system, comprising:
a light source that generates light of a wavelength λ; and
a material measure in the form of an amplitude grating that receives said light, wherein said material measure comprises:
a first reflecting layer;
a second transparent layer having a refractive index n and a thickness d₂; and
a third layer, which is partially transparent to said light and said third layer comprises a measuring graduation, wherein said second layer is arranged between said first layer and said third layer and said thickness d₂ fits the inequality
d₂<λ/(4·n).

15. The position measuring system in accordance with claim 14, wherein said first layer is applied to a base layer.

16. The position measuring system in accordance with claim 14, wherein said first layer comprises gold.

17. The position measuring system in accordance with claim 14, wherein said second layer comprises SiO₂.

18. The position measuring system in accordance with claim 16, wherein said second layer comprises SiO₂.

19. The position measuring system in accordance with claim 14, wherein said third layer comprises chromium.

20. The position measuring system in accordance with claim 16, wherein said third layer comprises chromium.

21. The position measuring system in accordance with claim 17, wherein said third layer comprises chromium.

22. The position measuring system in accordance with claim 18, wherein said third layer comprises chromium.

23. The position measuring system in accordance with claim 14, wherein said third layer has a thickness d₂ of less than 10 nm.

24. The position measuring system in accordance with claim 23, wherein said third layer has a thickness d₂ of less than 5 nm.

25. The position measuring system in accordance with claim 14, wherein said third layer has a degree of reflection of less than 50%.
